(19) United States
(12) Patent Application Publication
(10) Pub. No.: US 2025/0300393 A1
(43) Pub. Date: Sep. 25, 2025

(54) CONNECTOR AND CONNECTOR COMPONENT GROUP

(71) Applicant: IRISO ELECTRONICS CO., LTD., Yokohama-shi (JP)

(72) Inventors: Hiroaki YUKUTAKE, Yokohama-shi (JP); Hitoshi SUZUKI, Yokohama-shi (JP)

(21) Appl. No.: 19/086,198

(22) Filed: Mar. 21, 2025

(30) Foreign Application Priority Data
Mar. 22, 2024 (JP) 2024-047324

(51) Int. Cl. H01R 13/514; H01R 12/73

(52) U.S. Cl. CPC H01R 13/514; H01R 12/737

(57) ABSTRACT

A connector 10 includes plural terminal units 30A and 30B and a base housing 20 including plural accommodating portions 25 in which the plural terminal units 30A and 30B are accommodated. The plural terminal units 30A and 30B include a first terminal unit 30A (see FIGS. 5 and 6) and a second terminal unit 30B (see FIGS. 7 and 8) having different functions. The plural accommodating portions 25 include a common accommodating portion 25 capable of accommodating any one of the first terminal unit 30A and the second terminal unit 30B.

### CROSS-REFERENCE TO RELATED APPLICATION

This application claims priority under 35 USC 119 from Japanese Patent application No. 2024-047324 filed on Mar. 22, 2024, the disclosure of which is incorporated by reference herein in its entirety.

### BACKGROUND

### Technical Field

The present disclosure relates to a connector and a connector component group.

### Related Art

Japanese Patent Application Laid-Open (JP-A) No. 2023-28570 discloses a connector including two types of terminal units having different functions. The connector includes a plurality of terminal units including two types of terminal units, and a base housing. The base housing includes a plurality of accommodating portions in which the plurality of terminal units are accommodated.

### SUMMARY OF THE INVENTION

An object of the present disclosure is to provide a connector and a connector component group that enable easy variation expansion.

A connector according to a first aspect is a connector including: a plurality of terminal units; and a base housing including a plurality of accommodating portions in which the plurality of terminal units are accommodated, in which the plurality of terminal units include a first terminal unit and a second terminal unit having different functions, and the plurality of accommodating portions include a common accommodating portion configured to accommodate any one of the first terminal unit and the second terminal unit.

In the present aspect, the connector includes the plurality of terminal units and the base housing including the plurality of accommodating portions in which the plurality of terminal units are accommodated. The plurality of terminal units include a first terminal unit and a second terminal unit having different functions.

Therefore, it is possible to implement the connector including the first terminal unit and the second terminal unit having different functions.

An aspect in which an accommodating portion in which the first terminal unit is accommodated among the plurality of accommodating portions is an accommodating portion dedicated to the first terminal unit, and an accommodating portion in which the second terminal unit is accommodated among the plurality of accommodating portions is an accommodating portion dedicated to the second terminal unit is assumed (see JP-A No. 2023-28570). However, in such an aspect, in order to manufacture a connector with different arrangements of the first terminal unit and the second terminal unit, it is necessary to newly prepare base housings having different structures. This is an obstacle to variation expansion of the connector.

Therefore, in the aspect, the plurality of accommodating portions include an accommodating portion (common accommodating portion) capable of accommodating any one of the first terminal unit and the second terminal unit.

Therefore, it is possible to manufacture the connector with the different arrangements of the terminal units and by using the base housing having the same structure. As a result, easy variation expansion of the connector is achieved.

In an embodiment described below, the first terminal unit is a coaxial terminal unit, and the second terminal unit is a differential transmission terminal unit. However, the aspect is not limited thereto. Specific examples of the first terminal unit or the second terminal unit include, in addition to the above, a signal terminal unit (low-speed terminal unit), an optical terminal unit, and a power supply terminal unit.

In the embodiment described below, the plurality of terminal units do not include terminal units other than the first terminal unit and the second terminal unit. However, the plurality of terminal units according to the aspect is not limited thereto, and may include a third terminal unit, a fourth terminal unit, and the like.

In the embodiment described below, the plurality of terminal units include a plurality of types (two types) of terminal units having different functions, and the plurality of accommodating portions includes a common accommodating portion capable of accommodating any one of the plurality of types (two types) of terminal units. That is, the common accommodating portion is an accommodating portion capable of accommodating any one of all the types of terminal units included in the connector. However, the common accommodating portion according to the aspect is not limited thereto. For example, the common accommodating portion need not be able to accommodate one or more types of terminal units among three or more types of terminal units included in the connector.

In the embodiment described below, each of the plurality of accommodating portions is the common accommodating portion. However, the aspect is not limited thereto. The plurality of accommodating portions may include an accommodating portion that is not the common accommodating portion.

In the embodiment described below, the connector includes a regulating member. However, the connector according to the aspect is not limited thereto.

In the embodiment described below, the connector is a right angle type connector. However, the aspect is not limited thereto.

In the embodiment described below, one terminal unit is configured to be couplable to two mating terminal units. However, the terminal unit according to the aspect is not limited thereto.

In the embodiment described below, the base housing includes at least one partition wall disposed between two adjacent accommodating portions of the plurality of accommodating portions. However, the aspect is not limited thereto, and the partition wall does not have to be present between two adjacent accommodating portions among the plurality of accommodating portions.

According to a second aspect, in the connector according to the first aspect, each of the plurality of accommodating portions is a common accommodating portion capable of accommodating any one of the first terminal unit and the second terminal unit.

In the present aspect, each of the plurality of accommodating portions is the common accommodating portion capable of accommodating any one of the first terminal unit and the second terminal unit.

Therefore, easier variation expansion of the connector is achieved.

According to a third aspect, in the connector according to the first or second aspect, the connector is a right angle type connector attached to a mounting surface of a circuit board, in a case where a normal direction of the mounting surface is defined as a top direction, a direction in which a mating connector is disposed with respect to the connector in a direction parallel to the mounting surface is defined as a front direction, and a direction perpendicular to both the top direction and the front direction is defined as a width direction, the base housing includes a pair of side walls which is provided at an interval in the width direction and between which the plurality of accommodating portions are formed, a top wall connecting upper ends of the pair of side walls, and a bottom wall connecting lower ends of the pair of side walls, and each of the plurality of accommodating portions is open at a bottom.

In the present aspect, the connector is the right angle type connector attached to the mounting surface of the circuit board. The base housing includes the pair of side walls provided at an interval in the width direction, the top wall connecting the upper ends of the pair of side walls, and the bottom wall connecting the lower ends of the pair of side walls. The plurality of accommodating portions are formed between the pair of side walls.

In the aspect, each of the plurality of accommodating portions is open at the bottom.

Therefore, the terminal unit and the circuit board can be coupled using the opened portion.

According to a fourth aspect, in the connector according to the third aspect, the base housing includes at least one partition wall disposed between two adjacent accommodating portions among the plurality of accommodating portions, and the partition wall connects the top wall and the bottom wall.

By the way, for example, the base housing may be warped and deformed in a case where a distance between the pair of side walls is large.

Therefore, in the present aspect, the base housing includes at least one partition wall. The partition wall is disposed between two adjacent accommodating portions among the plurality of accommodating portions, and connects the top wall and the bottom wall.

Therefore, the warpage of the base housing can be suppressed by the at least one partition wall.

In the embodiment described below, a rear surface of the partition wall and a rear surface of the top wall are flush with each other. However, the aspect is not limited thereto.

In the embodiment described below, a lower surface of the partition wall and a lower surface of the bottom wall are flush with each other. However, the aspect is not limited thereto.

According to a fifth aspect, in the connector according to any one of the first to fourth aspects, the first terminal unit includes an inner terminal portion including at least one inner terminal, an outer terminal portion surrounding the inner terminal portion, and a dielectric portion holding the inner terminal portion and the outer terminal portion.

In the present aspect, the first terminal unit includes the inner terminal portion including at least one inner terminal, the outer terminal portion surrounding the inner terminal portion, and the dielectric portion holding the inner terminal portion and the outer terminal portion.

Therefore, the connector more suitable for high-speed transmission can be obtained as compared with an aspect in which the first terminal unit does not include the outer terminal portions.

In the embodiment described below, the second terminal unit also includes an inner terminal portion, an outer terminal portion, and a dielectric portion. However, the second terminal unit according to the aspect is not limited thereto.

According to a sixth aspect, in the connector according to the fifth aspect, the dielectric portion is molded by insert molding using the inner terminal portion as an insert component, and the dielectric portion includes an intervening portion interposed between the inner terminal portion and the outer terminal portion.

In the present aspect, the dielectric portion is molded by insert molding using the inner terminal portion as the insert component. The dielectric portion includes the intervening portion interposed between the inner terminal portion and the outer terminal portion.

Therefore, the dielectric portion including the intervening portion can be integrally formed.

According to a seventh aspect, in the connector according to the first to fourth aspects, the first terminal unit includes a first inner terminal portion including at least one first inner terminal, a second inner terminal portion including at least one second inner terminal, an outer terminal portion separately surrounding the first inner terminal portion and the second inner terminal portion, and a dielectric portion holding the first inner terminal portion, the second inner terminal portion, and the outer terminal portion.

In the present aspect, the first terminal unit includes the first inner terminal portion, the second inner terminal portion, the outer terminal portion separately surrounding the first inner terminal portion and the second inner terminal portion, and the dielectric portion holding the first inner terminal portion, the second inner terminal portion, and the outer terminal portion.

Therefore, the number of terminal units can be reduced as compared with an aspect in which the first terminal unit does not include the second inner terminal portion.

In the embodiment described below, the second terminal unit also includes a first inner terminal portion, a second inner terminal portion, an outer terminal portion, and a dielectric portion. However, the second terminal unit according to the aspect is not limited thereto.

According to an eighth aspect, in the connector according to the seventh aspect, the dielectric portion is molded by insert molding using the first inner terminal portion and the second inner terminal portion as insert components, and the dielectric portion includes a first intervening portion interposed between the first inner terminal portion and the outer terminal portion, and a second intervening portion interposed between the second inner terminal portion and the outer terminal portion.

In the present aspect, the dielectric portion is molded by insert molding using the first inner terminal portion and the second inner terminal portion as the insert components. The dielectric portion includes the first intervening portion interposed between the first inner terminal portion and the outer terminal portion, and the second intervening portion interposed between the second inner terminal portion and the outer terminal portion.

Therefore, the dielectric portion including the first intervening portion and the second intervening portion can be integrally formed.

A connector component group according to a ninth aspect is a connector component group for manufacturing a connector, the connector component group including: a plurality of types of terminal units including a first terminal unit and a second terminal unit having different functions; and a base housing including at least one accommodating portion in which the terminal unit is accommodated, in which the at least one accommodating portion includes a common accommodating portion configured to accommodate any one of the first terminal unit and the second terminal unit.

In the present aspect, the connector component group includes the plurality of terminal units and the base housing including at least one accommodating portion in which the terminal unit is accommodated. The plurality of terminal units include the first terminal unit and the second terminal unit having different functions.

Furthermore, in the aspect, the at least one accommodating portion includes an accommodating portion (common accommodating portion) capable of accommodating any one of the first terminal unit and the second terminal unit.

Therefore, it is possible to manufacture the connector with the different arrangements of the terminal units and by using the base housing having the same structure. As a result, easy variation expansion of the connector is achieved.

In the embodiment described below, the base housing includes a plurality of accommodating portions. However, the base housing according to the aspect is not limited thereto, and may include only one accommodating portion.

In the embodiment described below, the connector includes a plurality of terminal units, and the plurality of terminal units include the first terminal unit and the second terminal unit. However, the connector manufactured from the connector component group according to the aspect is not limited thereto. For example, all the plurality of terminal units included in the connector may be the first terminal units.

### BRIEF DESCRIPTION OF THE DRAWINGS

FIG. 1 is a perspective view of a board connector;

FIG. 2 is a perspective view of the board connector and a cable connector;

FIG. 3 is an exploded perspective view of the board connector;

FIG. 4 is a perspective view of a first terminal unit;

FIG. 5 is an exploded perspective view of the first terminal unit;

FIG. 6 is a perspective view of a second terminal unit;

FIG. 7 is an exploded perspective view of the second terminal unit;

FIG. 8 is an enlarged view of an accommodating portion of a base housing;

FIG. 9 is a cross-sectional view of the board connector at a cross-sectional position corresponding to the first terminal unit; and

FIG. 10 is a cross-sectional view of the board connector at a cross-sectional position corresponding to the second terminal unit.

### DETAILED DESCRIPTION OF THE INVENTION

Hereinafter, a board connector 10 according to an embodiment of a connector of the present disclosure will be described.

An arrow X direction illustrated in each figure indicates one side in a width direction of the connector, an arrow Y direction indicates a front direction of the connector, and an arrow Z direction indicates a top direction of the connector. However, such terms do not limit a posture of the connector in a use state. Hereinafter, the directions simply referred to as the width direction, the front direction, and the top direction mean the width direction of the connector, the front direction of the connector, and the top direction of the connector, respectively.

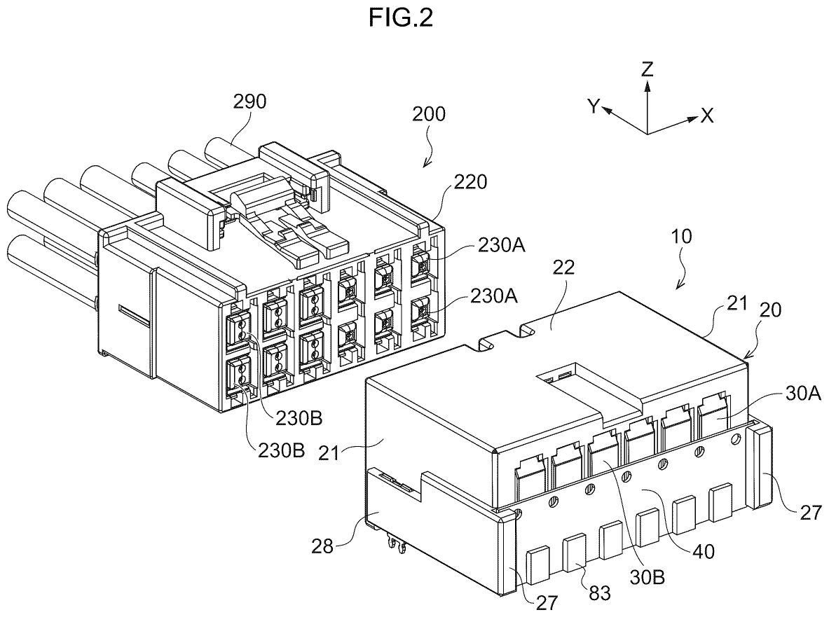

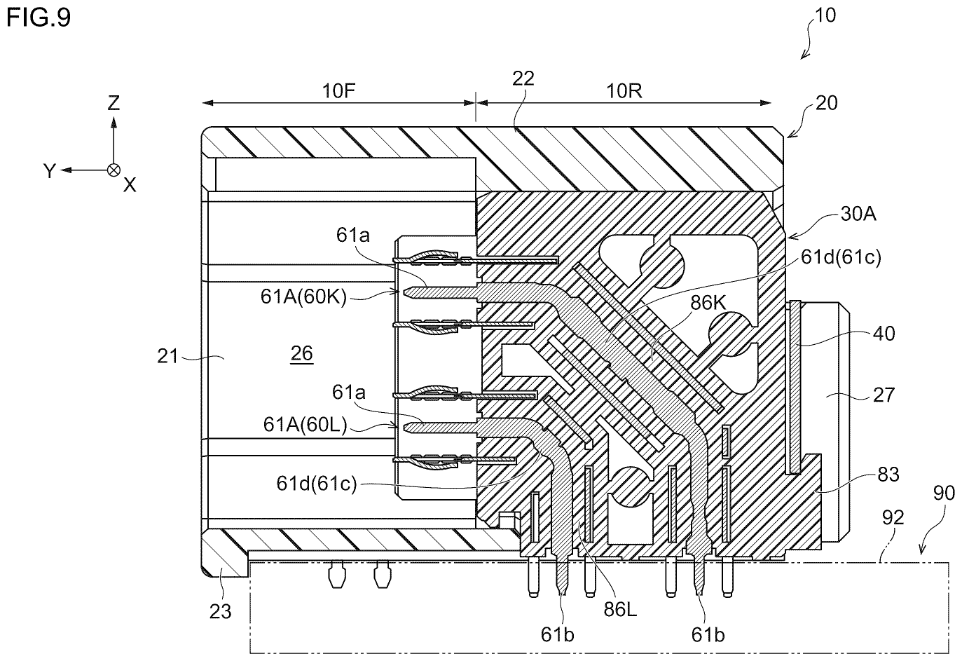

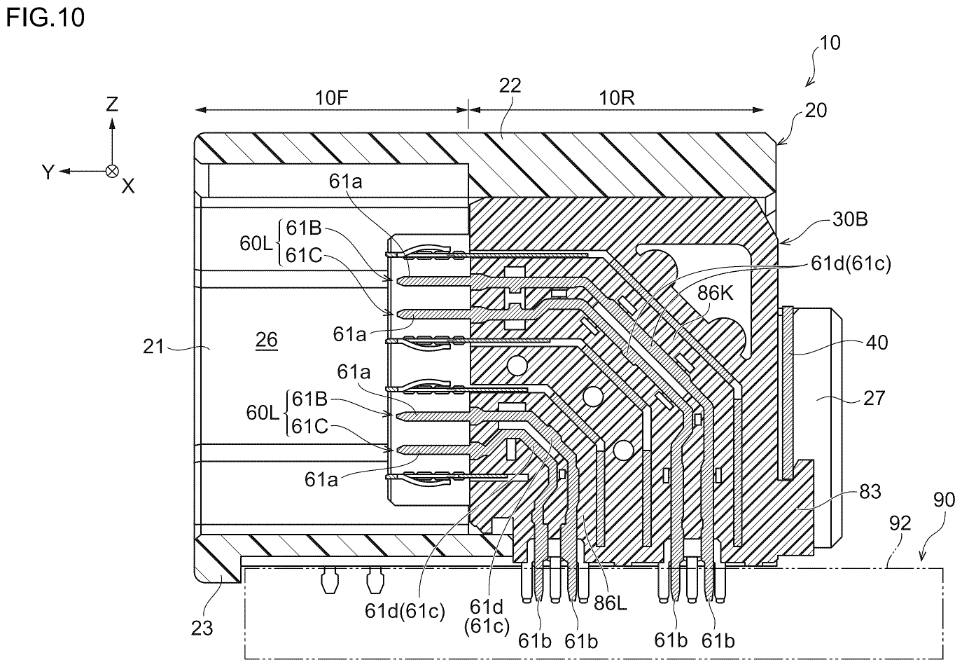

As illustrated in FIGS. 9 and 10, the board connector 10 is attached to a mounting surface 92 of a circuit board 90 serving as an “attachment target”. The board connector 10 is configured to be couplable to a cable connector 200 (see FIG. 2) serving as a “mating connector”. A coupling direction in which the board connector 10 and the cable connector 200 are coupled to each other is a front-rear direction.

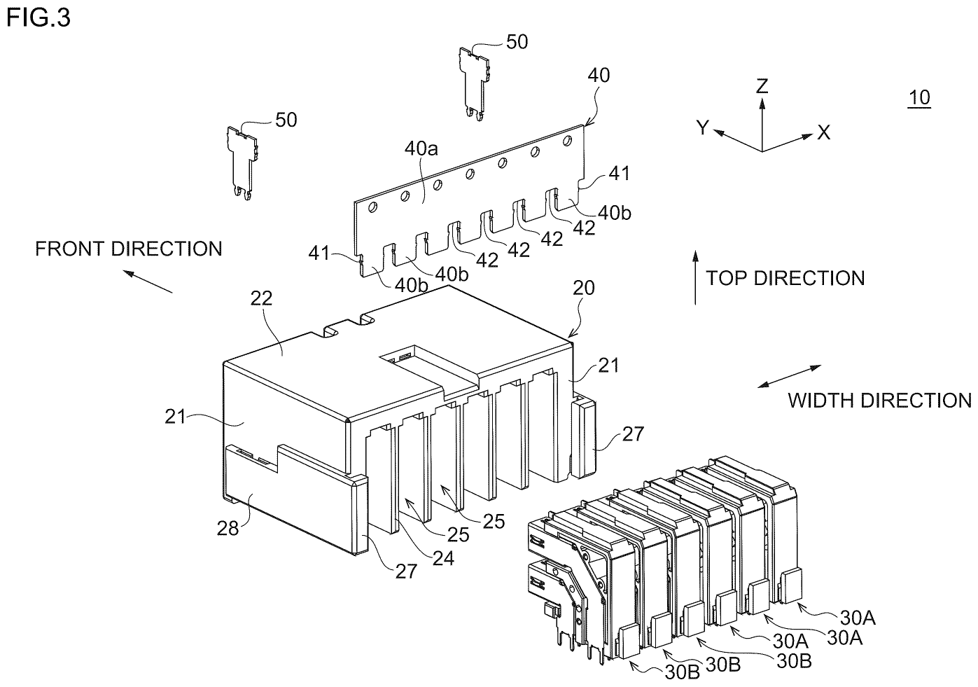

As illustrated in FIG. 3, the board connector 10 includes a base housing 20, a plurality of terminal units 30A and 30B accommodated in the base housing 20, a regulating member 40, and two reinforcing members 50.

### (Base Housing 20)

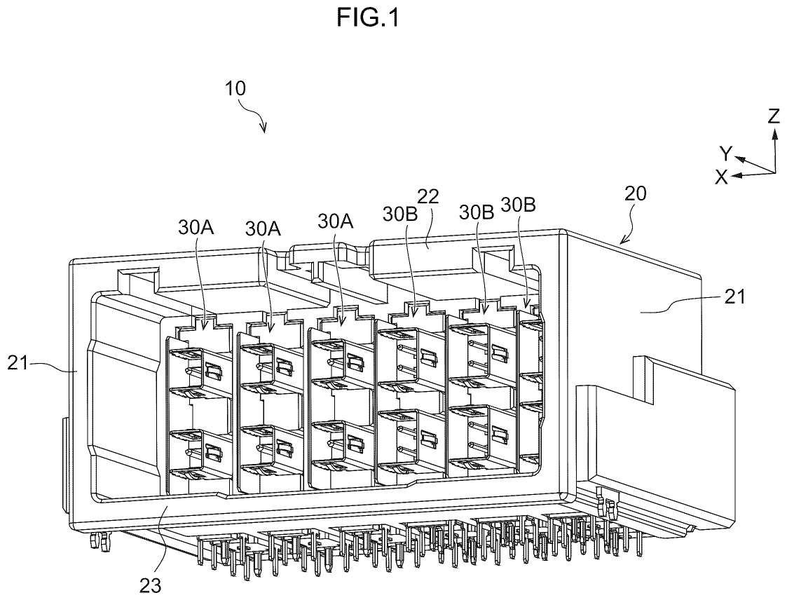

The base housing 20 includes a pair of side walls 21, a top wall 22, a bottom wall 23 (see FIG. 1), and a plurality of (five) partition walls 24.

The pair of side walls 21 are walls whose thickness direction is oriented in the width direction, and are provided at an interval in the width direction. The top wall 22 connects upper ends of the pair of side walls 21 in the width direction. The bottom wall 23 connects lower ends of the pair of side walls 21 in the width direction.

A plurality of accommodating portions 25 (see FIG. 3) in which the plurality of terminal units 30A and 30B are accommodated are formed at a portion corresponding to a connector rear portion 10R (see FIGS. 9 and 10) in a space between the pair of side walls 21. Each of the plurality of partition walls 24 is provided between two adjacent accommodating portions 25 among the plurality of accommodating portions 25. Structures (for example, width dimensions) of the respective accommodating portions 25 are the same as each other.

As illustrated in FIGS. 9 and 10, a rear end of the bottom wall 23 is positioned on a front side of rear ends of the side walls 21 and the top wall 22. Therefore, the bottom wall 23 is not present in most of the connector rear portion 10R. Therefore, the accommodating portion 25 is open at a bottom. Inner terminals 61 and outer terminals 71 and 72 of the terminal units 30A and 30B are electrically coupled to the circuit board 90 using the opened portions.

As illustrated in FIGS. 9 and 10, a portion corresponding to a connector front portion 10F in the space between the pair of side walls 21 is an insertion space 26 into which a part of the mating connector 200 is inserted. Front side portions of the inner terminals 61 and the outer terminals 71 and 72 included in the terminal units 30A and 30B are disposed in the insertion space 26.

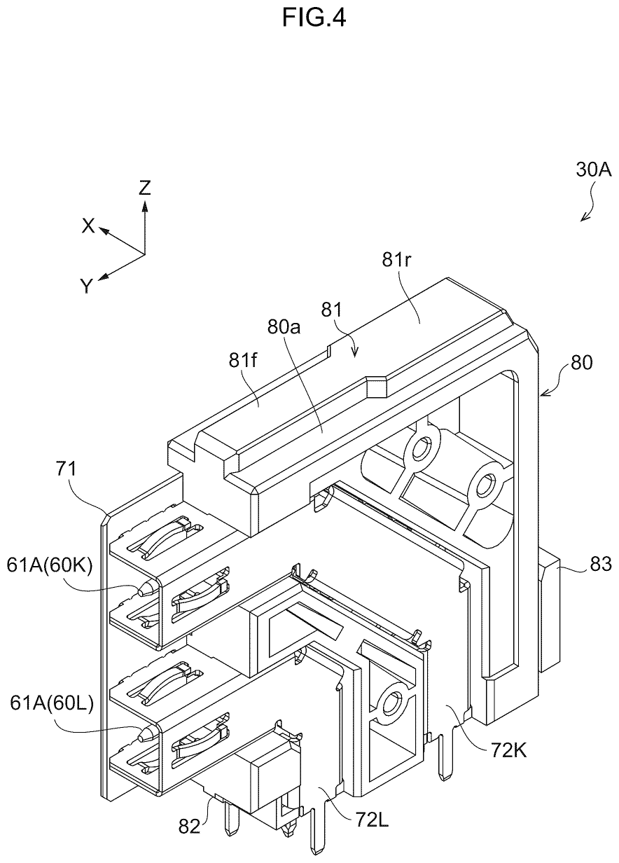

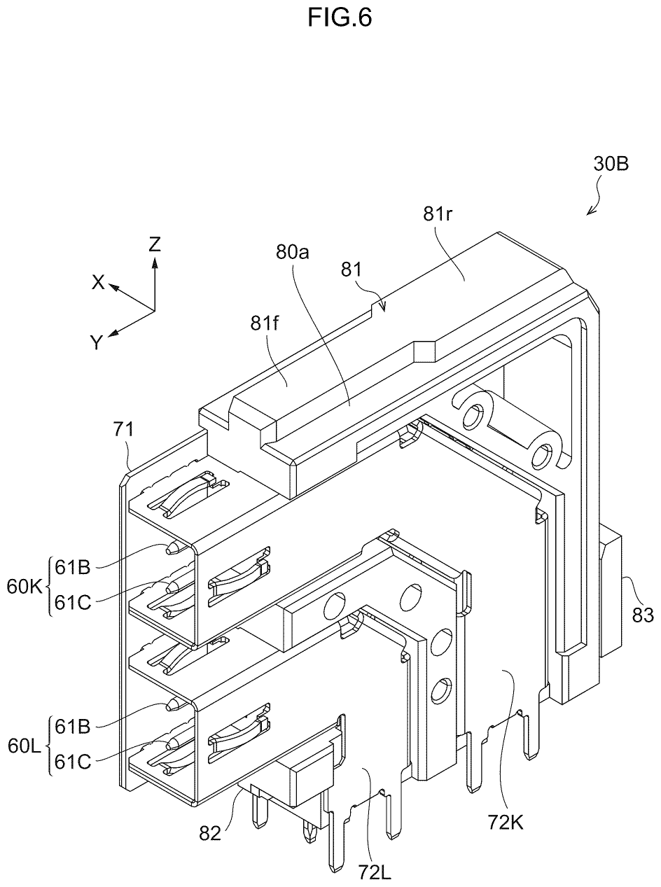

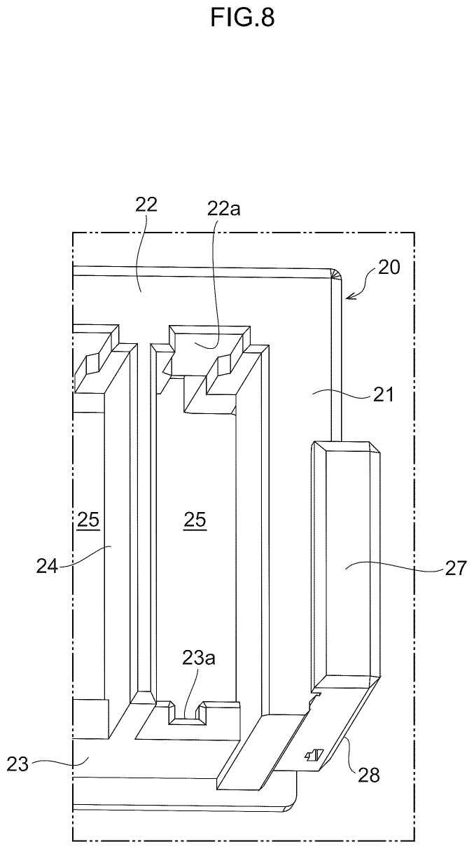

As illustrated in FIG. 8, the top wall 22 has an upper engagement groove 22a. The upper engagement groove 22a is provided for each accommodating portion 25. The plurality of upper engagement grooves 22a have the same structure. The upper engagement groove 22a is a groove formed on a lower surface side of the top wall 22 and extending in the front-rear direction. The upper engagement groove 22a accommodates a part (an upper engagement portion 81, see FIGS. 4 and 6) of each of the terminal units 30A and 30B. As a result, the upper engagement groove 22a has a function of positioning each of the terminal units 30A and 30B in the width direction with respect to the base housing 20. The upper engagement groove 22a is provided at a portion of the top wall 22 that corresponds to the connector rear portion 10R.

As illustrated in FIG. 8, the bottom wall 23 has a lower engagement groove 23a. The lower engagement groove 23a is provided for each accommodating portion 25. The plurality of lower engagement grooves 23a have the same structure. The lower engagement groove 23a is a groove formed on an upper surface side of the bottom wall 23 and extending in the front-rear direction. The lower engagement groove 23a accommodates a part (a lower engagement portion 82, see FIGS. 4 and 6) of each of the terminal units 30A and 30B. As a result, the lower engagement groove 23a has a function of positioning each of the terminal units 30A and 30B in the width direction with respect to the base housing 20. The lower engagement groove 23a is provided at a portion of the bottom wall 23 that corresponds to the connector rear portion 10R.

As illustrated in FIGS. 2 and 3, the base housing 20 includes regulating member holding portions 27 that hold the regulating member 40. The regulating member holding portions 27 are implemented by a pair of protrusions 27. Each of the pair of protrusions 27 protrudes rearward from each of the pair of side walls 21. An upper end of the protrusion 27 is positioned below an upper surface of the top wall 22. A press-fitting groove into which a part (lower portion) of the regulating member 40 is press-fitted is formed on an inner surface of each of the protrusions 27 in the width direction.

As illustrated in FIGS. 2 and 3, the base housing 20 includes two reinforcing member holding portions 28 that hold the two reinforcing members 50. The reinforcing member holding portion 28 protrudes outward from the side wall 21 in the width direction. The reinforcing member 50 is press-fitted into the reinforcing member holding portion 28 from above. An upper end of the reinforcing member holding portion 28 is positioned below the upper surface of the top wall 22 and below the upper end of the protrusion 27. The reinforcing member 50 is held at a position corresponding to the connector front portion 10F.

### (Terminal Units 30A and 30B)

As illustrated in FIG. 3, the plurality of terminal units 30A and 30B include a plurality of first terminal units 30A and a plurality of second terminal units 30B. The plurality of first terminal units 30A are provided on one side in the width direction, and the plurality of second terminal units 30B are provided on the other side in the width direction. The first terminal unit 30A is a coaxial terminal unit, and the second terminal unit 30B is a differential transmission terminal unit.

As illustrated in FIG. 2, the cable connector 200 includes a mating base housing 220 and a plurality of mating terminal units 230A and 230B accommodated in the mating base housing 220. The cable connector 200 is attached to a plurality of cables 290. Specifically, each of the plurality of mating terminal units 230A and 230B is attached to the cable 290. One first terminal unit 30A can be coupled to two mating first terminal units 230A, and one second terminal unit 30B can be coupled to two mating second terminal units 230B.

The first terminal unit 30A and the second terminal unit 30B have many points in common. Therefore, corresponding members and portions of the first terminal unit 30A and the second terminal unit 30B are denoted by the same reference numerals.

Hereinafter, when describing a configuration common to the first terminal unit 30A and the second terminal unit 30B, the first terminal unit 30A and the second terminal unit 30B will be simply referred to as the terminal unit 30.

As illustrated in FIGS. 4 to 7, the terminal unit 30 includes two inner terminal portions 60K and 60L, outer terminal portions 71, 72K, and 72L, and a dielectric portion 80. The two inner terminal portions 60K and 60L include a first inner terminal portion 60K and a second inner terminal portion 60L.

Hereinafter, when describing a configuration common to the first inner terminal portion 60K and the second inner terminal portion 60L, the first inner terminal portion 60K and the second inner terminal portion 60L will be simply referred to as the inner terminal portion 60.

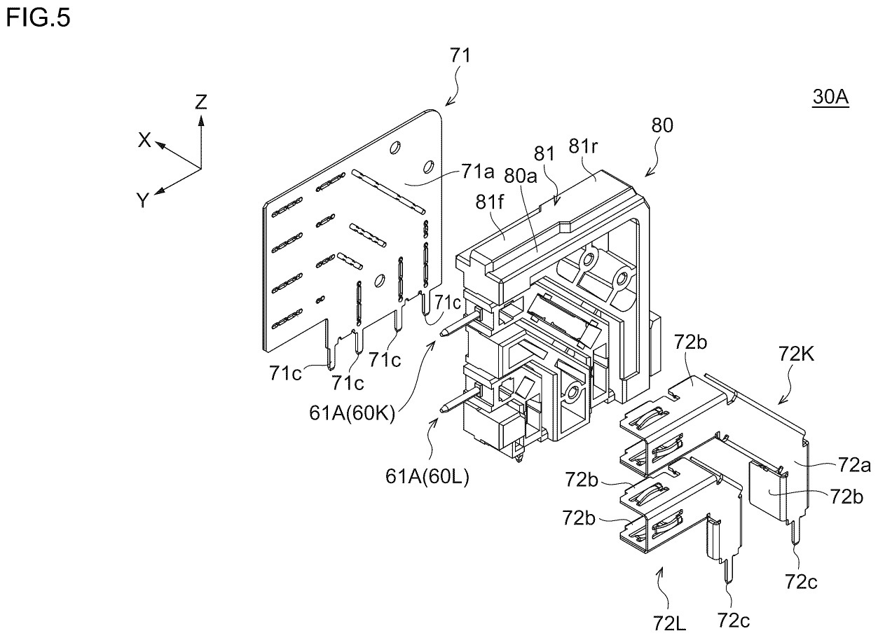

As illustrated in FIGS. 4 and 5, the inner terminal portion 60 of the first terminal unit 30A includes a first inner terminal 61A.

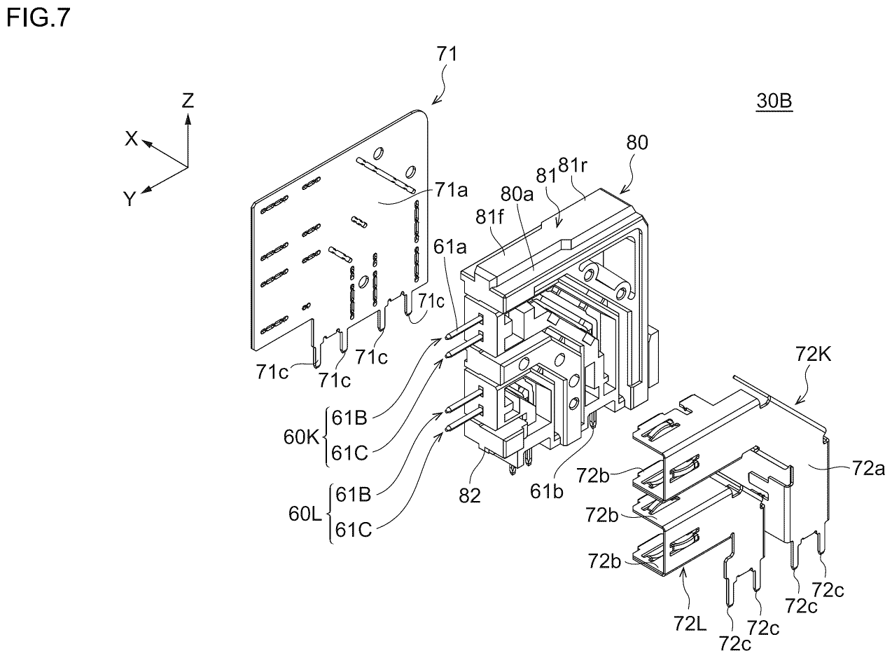

As illustrated in FIGS. 6 and 7, the inner terminal portion 60 of the second terminal unit 30B includes a second inner terminal 61B and a third inner terminal 61C.

Hereinafter, when describing a configuration common to the first inner terminal 61A, the second inner terminal 61B, and the third inner terminal 61C, the first inner terminal 61A, the second inner terminal 61B, and the third inner terminal 61C will be simply referred to as the inner terminal 61.

As illustrated in FIGS. 9 and 10, the inner terminals 61 included in one terminal unit 30 extend in the same cross section (a cross section perpendicular to the width direction). The inner terminal 61 includes a contact portion 61a that comes into contact with a terminal of the cable connector 200, a coupling portion 61b that is coupled to the circuit board 90, and a connecting portion 61c that connects the contact portion 61a and the coupling portion 61b.

As illustrated in FIGS. 9 and 10, the contact portion 61a is exposed from the dielectric portion 80 and extends in the front-rear direction. The coupling portion 61b is exposed from the dielectric portion 80 and extends in the vertical direction. The connecting portion 61c is held in a state of being buried in the dielectric portion 80. The connecting portion 61c has an inclined portion 61d extending in a direction inclined downward toward the rear direction.

Next, the second inner terminal 61B and the third inner terminal 61C included in the inner terminal portion 60 of the second terminal unit 30B will be described with reference to FIG. 10.

As illustrated in FIG. 10, the contact portion 61a of the second inner terminal 61B and the contact portion 61a of the third inner terminal 61C extend in parallel. The coupling portion 61b of the second inner terminal 61B and the coupling portion 61b of the third inner terminal 61C extend in parallel. The inclined portion 61d of the second inner terminal 61B and the inclined portion 61d of the third inner terminal 61C extend in parallel.

As illustrated in FIG. 10, an interval between the inclined portion 61d of the second inner terminal 61B and the inclined portion 61d of the third inner terminal 61C is smaller than an interval between the contact portion 61a of the second inner terminal 61B and the contact portion 61a of the third inner terminal 61C, and smaller than an interval between the coupling portion 61b of the second inner terminal 61B and the coupling portion 61b of the third inner terminal 61C. As a result, an electrical length of the third inner terminal 61C is brought close to an electrical length of the second inner terminal 61B.

As illustrated in FIGS. 4 to 7, the outer terminal portions 71, 72K, and 72L separately surround the first inner terminal portion 60K and the second inner terminal portion 60L.

Specifically, the outer terminal portions 71, 72K, and 72L include a first outer terminal 71 and two second outer terminals 72K and 72L. Each of the first outer terminal 71 and the two second outer terminals 72K and 72L is formed of a metal plate. The two second outer terminals 72K and 72L are disposed on the other side in the width direction with respect to the first outer terminal 71. One inner terminal portion 60K of the two inner terminal portions 60K and 60L is surrounded by the first outer terminal 71 and one second outer terminal 72K. The other inner terminal portion 60L of the two inner terminal portions 60K and 60L is surrounded by the first outer terminal 71 and the other second outer terminal 72L.

Hereinafter, when describing a configuration common to the one second outer terminal 72K and the other second outer terminal 72L, the one second outer terminal 72K and the other second outer terminal 72L will be simply referred to as the second outer terminal 72.

As illustrated in FIGS. 5 and 7, the first outer terminal 71 includes a first main plate portion 71a whose thickness direction is oriented in the width direction, and a plurality of coupling piece portions 71c protruding from the first main plate portion 71a and coupled to the circuit board 90.

As illustrated in FIGS. 5 and 7, the second outer terminal 72 includes a second main plate portion 72a whose thickness direction is oriented in the width direction, a pair of side plate portions 72b extending from ends of the second main plate portion 72a toward the first main plate portion 71a of the first outer terminal 71, and a plurality of coupling piece portions 72c protruding from the second main plate portion 72a and coupled to the circuit board 90.

The dielectric portion 80 is formed of a resin material. Specifically, the dielectric portion 80 is molded by insert molding in which the plurality of inner terminals 61 included in the two inner terminal portions 60K and 60L are used as insert components. The first outer terminal 71 and the two second outer terminals 72K and 72L included in the outer terminal portions 71, 72K, and 72L are assembled to the insert-molded articles 60 and 80 afterward.

As illustrated in FIGS. 4 and 6, the dielectric portion 80 includes the upper engagement portion 81. The upper engagement portion 81 is a portion that is engaged with the upper engagement groove 22a of the base housing 20. The upper engagement portion 81 is a protruding portion that protrudes upward from an upper surface 80a of the dielectric portion 80 and extends in the front-rear direction. The upper engagement portion 81 has a front portion 81f having a small width dimension and a rear portion 82r having a small width dimension.

As illustrated in FIGS. 4 and 6, the dielectric portion 80 includes the lower engagement portion 82. The lower engagement portion 82 is a portion that is engaged with the lower engagement groove 23a of the base housing 20. The lower engagement portion 82 is a protruding portion that protrudes downward. The lower engagement portion 82 is provided at a front end portion of the dielectric portion 80.

As illustrated in FIGS. 4 and 6, the dielectric portion 80 includes a rear engagement portion 83. The rear engagement portion 83 protrudes rearward from a rear surface of the dielectric portion 80. As illustrated in FIG. 2, the rear engagement portion 83 is a portion press-fitted into a recess 42 (see FIG. 3) of the regulating member 40. The rear engagement portion 83 is provided at a lower end portion of the dielectric portion 80.

An arrangement and a structure of the upper engagement portion 81, the lower engagement portion 82, and the rear engagement portion 83 described above are common to the first terminal unit 30A and the second terminal unit 30B. As a result, the first terminal unit 30A and the second terminal unit 30B have compatibility with each other in terms of accommodation in the accommodating portion 25.

### (Regulating Member 40)

As illustrated in FIGS. 2 and 3, the regulating member 40 is press-fitted between the pair of protrusions 27 of the regulating member holding portions 27 of the base housing 20. The regulating member 40 has a pair of outer projections 41. Accordingly, the regulating member 40 is held by the base housing 20.

The regulating member 40 has the recess 42. The recess 42 is provided corresponding to each of the terminal units 30A and 30B. The rear engagement portion 83 of each of the terminal units 30A and 30B is press-fitted into the recess 42. The recess 42 is a recess that is provided at a lower portion of the regulating member 40 and is open at a bottom.

In other words, as illustrated in FIG. 3, the regulating member 40 includes a main body portion 40a and a plurality of extending portions 40b extending downward from the main body portion 40a. Each of the extending portions 40b has projections on both sides in the width direction. A recess formed between two adjacent extending portions 40b of the plurality of extending portions 40b is the above-described recess 42. One of a pair of projecting portions included in the outermost extending portion 40b in the width direction among the plurality of extending portions 40b is the above-described outer projection 41. The regulating member 40 is formed of, for example, a metal plate. The regulating member 40 does not have a portion where a plate that is a material is bent.

### (Reinforcing Member 50)

The reinforcing member 50 is held by the reinforcing member holding portion 28 of the base housing 20, and is fixed to the circuit board 90 by soldering. Therefore, the reinforcing member 50 has a function of reinforcing an attachment strength of the connector 10 to the circuit board 90.

The board connector 10 according to the present embodiment is assembled by the following procedure.

First, the plurality of terminal units 30A and 30B are assembled to the base housing 20. That is, the plurality of terminal units 30A and 30B are inserted into the plurality of accommodating portions 25 of the base housing 20 from behind the base housing 20.

Next, the regulating member 40 is held by the regulating member holding portions 27 of the base housing 20, and the rear engagement portion 83 of the dielectric portion 80 of each of the terminal units 30A and 30B is press-fitted into each recess 42 of the regulating member 40.

Through the above steps, the board connector 10 is assembled.

### Actions and Effects

Next, actions and effects of the embodiment will be described.

In the embodiment, as illustrated in FIG. 3, the connector 10 includes the plurality of terminal units 30A and 30B and the base housing 20 including the plurality of accommodating portions 25 in which the plurality of terminal units 30A and 30B are accommodated. The plurality of terminal units 30A and 30B include the first terminal unit 30A (see FIGS. 5 and 6) and the second terminal unit 30B (see FIGS. 7 and 8) having different functions.

Therefore, it is possible to implement the connector 10 including the first terminal unit 30A and the second terminal unit 30B having different functions.

An aspect in which the accommodating portion 25 in which the first terminal unit 30A is accommodated among the plurality of accommodating portions 25 is an accommodating portion dedicated to the first terminal unit 30A, and the accommodating portion 25 in which the second terminal unit 30B is accommodated among the plurality of accommodating portions 25 is an accommodating portion dedicated to the second terminal unit 30B is assumed (see JP-A No. 2023-28570). However, in such an aspect, in order to manufacture a connector with different arrangements of the first terminal unit 30A and the second terminal unit 30B, it is necessary to newly prepare base housings having different structures. This is an obstacle to variation expansion of the connector.

Therefore, in the embodiment, as illustrated in FIGS. 3 and 9, the plurality of accommodating portions 25 include an accommodating portion 25 (common accommodating portion 25) capable of accommodating any one of the first terminal unit 30A and the second terminal unit 30B.

Therefore, it is possible to manufacture the connector 10 with the different arrangements of the terminal units 30A and 30B by using the base housing 20 having the same structure. As a result, easy variation expansion of the connector 10 is achieved.

In the embodiment, each of the plurality of accommodating portions 25 is the common accommodating portion 25 capable of accommodating any one of the first terminal unit 30A and the second terminal unit 30B.

Therefore, easier variation expansion of the connector 10 is achieved.

In the embodiment, as illustrated in FIGS. 10 and 11, the connector 10 is a right angle type connector attached to the mounting surface 92 of the circuit board 90. As illustrated in FIG. 3, the base housing 20 includes the pair of side walls 21 provided at an interval in the width direction, the top wall 22 connecting the upper ends of the pair of side walls 21, and the bottom wall 23 connecting the lower ends of the pair of side walls 21 (see FIGS. 9, 10, and 11). The plurality of accommodating portions 25 are formed between the pair of side walls 21.

Here, each of the plurality of accommodating portions 25 is open at the bottom.

Therefore, as illustrated in FIGS. 10 and 11, the terminal units 30A and 30B and the circuit board 90 can be coupled using the opened portion.

By the way, for example, the base housing 20 may be warped and deformed in a case where a distance between the pair of side walls 21 is large.

Therefore, in the embodiment, the base housing 20 includes at least one partition wall 24. As illustrated in FIG. 9, the partition wall 24 is disposed between two adjacent accommodating portions 25 among the plurality of accommodating portions 25, and connects the top wall 22 and the bottom wall 23.

Therefore, the warpage of the base housing 20 can be suppressed by the at least one partition wall 24.

In the embodiment, as illustrated in FIGS. 6 and 7, the first terminal unit 30A includes the inner terminal portion 60 including at least one inner terminal 61, the outer terminal portions 71, 72K, and 72L surrounding the inner terminal portion 60, and the dielectric portion 80 holding the inner terminal portion 60 and the outer terminal portions 71, 72K, and 72L.

Therefore, the connector 10 more suitable for high-speed transmission can be obtained as compared with an aspect in which the first terminal unit 30A does not include the outer terminal portions 71, 72K, and 72L.

In addition, in the embodiment, as illustrated in FIG. 6, the dielectric portion 80 is molded by insert molding using the inner terminal portion 60 as the insert component. As illustrated in FIG. 10, the dielectric portion 80 includes an intervening portion 86K intervening between the inner terminal portion 60 and the outer terminal portions 71, 72K, and 72L.

Therefore, the dielectric portion 80 including the intervening portion 86K can be integrally formed.

In the embodiment, as illustrated in FIGS. 6 and 7, the first terminal unit 30A includes the first inner terminal portion 60K, the second inner terminal portion 60L, the outer terminal portions 71, 72K, and 72L separately surrounding the first inner terminal portion 60K and the second inner terminal portion 60L, and the dielectric portion 80 holding the first inner terminal portion 60K, the second inner terminal portion 60L, and the outer terminal portions 71, 72K, and 72L.

Therefore, the number of terminal units 30A and 30B can be reduced as compared with an aspect in which the first terminal unit 30A does not include the second inner terminal portion 60L.

In the embodiment, as illustrated in FIG. 6, the dielectric portion 80 is molded by insert molding using the first inner terminal portion 60K and the second inner terminal portion 60L as the insert components. As illustrated in FIG. 10, the dielectric portion 80 includes the first intervening portion 86K interposed between the first inner terminal portion 60K and the outer terminal portions 71, 72K, and 72L, and a second intervening portion 86L interposed between the second inner terminal portion 60L and the outer terminal portions 71, 72K, and 72L.

Therefore, the dielectric portion 80 including the first intervening portion 86K and the second intervening portion 86L can be integrally formed.

FIG. 3 can also be regarded as illustrating a connector component group 10 for manufacturing the connector 10.

That is, the connector component group 10 includes the plurality of types (two types) of terminal units 30A and 30B including the first terminal unit 30A and the second terminal unit 30B having different functions, and the base housing 20 including at least one accommodating portion 25 in which the terminal unit 30A or 30B is housed. The at least one accommodating portion 25 includes the accommodating portion 25 (common accommodating portion 25) capable of accommodating any one of the first terminal unit 30A and the second terminal unit 30B.

Therefore, it is possible to manufacture the connector 10 with the different arrangements of the terminal units 30A and 30B by using the base housing 20 having the same structure. As a result, easy variation expansion of the connector 10 is achieved.

For example, the first terminal unit 30A may be accommodated in all of a plurality of (six) common accommodating portions 25 included in the base housing 20. Further, for example, the first terminal unit 30A may be accommodated in five common accommodating portions 25 among the six common accommodating portions 25 included in the base housing 20, and the second terminal unit 30B may be accommodated in the remaining one common accommodating portion 25.

Although the preferred embodiment of the connector of the disclosure has been described above, the disclosure is not limited thereto.

### REFERENCE SIGNS LIST

10 Board connector (connector and connector component group)
20 Base housing
21 Side wall
22 Top wall
23 Bottom wall
24 Partition wall
25 Accommodating portion (common accommodating portion)
30A First terminal unit (terminal unit)
30B Second terminal unit (terminal unit)
60K First inner terminal portion (inner terminal portion)
60L Second inner terminal portion (inner terminal portion)
61A First inner terminal (inner terminal)
61B Second inner terminal (inner terminal)
61C Third inner terminal (inner terminal)
71, 72K, 72L Outer terminal portion
80 Dielectric portion
86K First intervening portion (intervening portion)
86L Second intervening portion (intervening portion)
90 Circuit board
92 Mounting surface
200 Cable connector (mating connector)

What is claimed is:

1. A connector comprising:
a plurality of terminal units; and
a base housing including a plurality of accommodating portions in which the plurality of terminal units are accommodated, wherein
the plurality of terminal units include a first terminal unit and a second terminal unit having different functions, and
the plurality of accommodating portions include a common accommodating portion configured to accommodate any one of the first terminal unit and the second terminal unit.

2. The connector according to claim 1, wherein
each of the plurality of accommodating portions is a common accommodating portion configured to accommodate any one of the first terminal unit and the second terminal unit.

3. The connector according to claim 1, wherein
the connector is a right angle type connector attached to a mounting surface of a circuit board,
in a case where a normal direction of the mounting surface is defined as a top direction, a direction in which a mating connector is disposed with respect to the connector in a direction parallel to the mounting surface is defined as a front direction, and a direction perpendicular to both the top direction and the front direction is defined as a width direction,
the base housing includes:
a pair of side walls which is provided at an interval in the width direction and between which the plurality of accommodating portions are formed;
a top wall connecting upper ends of the pair of side walls; and
a bottom wall connecting lower ends of the pair of side walls, and
each of the plurality of accommodating portions is open at a bottom.

4. The connector according to claim 3, wherein
the base housing includes
at least one partition wall disposed between two adjacent accommodating portions among the plurality of accommodating portions, and
the partition wall connects the top wall and the bottom wall.

5. The connector according to claim 1, wherein
the first terminal unit includes:
an inner terminal portion including at least one inner terminal;
an outer terminal portion surrounding the inner terminal portion; and
a dielectric portion holding the inner terminal portion and the outer terminal portion.

6. The connector according to claim 5, wherein
the dielectric portion is molded by insert molding using the inner terminal portion as an insert component, and
the dielectric portion includes
an intervening portion interposed between the inner terminal portion and the outer terminal portion.

7. The connector according to claim 1, wherein
the first terminal unit includes:
a first inner terminal portion including at least one first inner terminal;
a second inner terminal portion including at least one second inner terminal;
an outer terminal portion separately surrounding the first inner terminal portion and the second inner terminal portion; and
a dielectric portion holding the first inner terminal portion, the second inner terminal portion, and the outer terminal portion.

8. The connector according to claim 7, wherein
the dielectric portion is molded by insert molding using the first inner terminal portion and the second inner terminal portion as insert components, and
the dielectric portion includes:
a first intervening portion interposed between the first inner terminal portion and the outer terminal portion; and
a second intervening portion interposed between the second inner terminal portion and the outer terminal portion.

9. A connector component group for manufacturing a connector, the connector component group comprising:
a plurality of types of terminal units including a first terminal unit and a second terminal unit having different functions; and
a base housing including at least one accommodating portion in which the terminal unit is accommodated,
wherein the at least one accommodating portion includes a common accommodating portion configured to accommodate any one of the first terminal unit and the second terminal unit.
